(19) United States
(12) Patent Application Publication
(10) Pub. No.: US 2019/0065088 A1
(43) Pub. Date: Feb. 28, 2019

(54) RANDOM ACCESS MEMORY POWER SAVINGS

(71) Applicant: Micron Technology, Inc., Boise, ID (US)

(72) Inventor: Sebastien Andre Jean, Meridian, ID (US)

(21) Appl. No.: 15/690,933

(22) Filed: Aug. 30, 2017

(51) Int. Cl. G06F 3/06

(52) U.S. Cl. CPC G06F 3/0625; G06F 3/0673; G06F 3/0647; G06F 3/0644

(57) ABSTRACT

Devices and techniques for random access memory power savings are disclosed herein. Data contained in RAM is compressed in response to obtaining a trigger. Here, the RAM organized into several discrete hardware components with a corresponding power control. The data contained in the RAM is replaced with the compressed data to free a discrete hardware component of the RAM. The discrete hardware component is then powered down via the corresponding power control.

### BACKGROUND

Memory devices are typically provided as internal, semiconductor, integrated circuits in computers or other electronic devices. There are many different types of memory, including volatile and non-volatile memory.

Volatile memory requires power to maintain its data, and includes random-access memory (RAM), dynamic random-access memory (DRAM), or synchronous dynamic random-access memory (SDRAM), among others.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment including a system for RAM power savings.

FIG. 2 illustrates an example of components in RAM subject to power control.

FIG. 3 illustrates an example of compressing RAM.

FIG. 4 illustrates an example flowchart of a method for RAM power savings.

FIG. 5 is a block diagram illustrating an example of a machine upon which one or more embodiments may be implemented.

### DETAILED DESCRIPTION

Volatile memory devices are often integral to system operations. Generally, they are byte addressable and thus directly accessible from processors, unlike storage devices that are addressable in pages, blocks, etc. Volatile memories like SRAM and DRAM are also fast enough to satisfy user expectations for device performance. These technologies, however, can be power hungry, with DRAM, for example requiring periodic refreshing and SRAM otherwise requiring power.

In power-sensitive devices, such as battery operated sensors, mobile phones, tablets, etc., power savings may become an important consideration. To address this issue, many volatile memory manufacturers have developed bi-modal operation for memories, a low-power and a high-power mode. Typically, the high-power mode operates with the same parameters as devices connected to mains power while the low-power mode involves a number of modifications to reduce power consumption, such as reducing data or address bus widths, reducing operating voltage, implementing temperature compensated refresh, deep power down (e.g., idle time based shutdown for the entire device), among others.

While existing volatile memory power reduction techniques help, additional power reduction may be achieved by trading some additional intermittent processing to actively clear memory areas and eliminate power to those areas. For example, RAM contents can be compressed to reduce the number of chips, ranks, or banks used to store the operating data for the device. In an example, a more aggressive paging (e.g., writing memory contents to storage devices such as a hard drive) policy is enacted to further reduce RAM contents.

These freeing techniques may be always one, or may be triggered at certain times, such as when the device's battery is low, when the device is idle—such as when a device screen is off, when a device system signals idleness, etc.—, during a defragmentation of the RAM, or during periodic intervals, which may be helpful for server-based power savings even when connected to mains power. The freed components are then powered down, saving additional energy and increasing longevity device energy reserves with a modest impact on performance. The selection, compression, and powering down may be performed by a memory controller, memory management unit (MMU), mobile management unit, or circuitry with power control over the RAM. Additional details and examples are provided below.

Electronic devices, such as mobile electronic devices (e.g., smart phones, tablets, etc.), electronic devices for use in automotive applications (e.g., automotive sensors, control units, driver-assistance systems, passenger safety or comfort systems, etc.), and internet-connected appliances or devices (e.g., internet-of-things (IoT) devices, etc.), have varying storage needs depending on, among other things, the type of electronic device, use environment, performance expectations, etc.

Electronic devices can be broken down into several main components: a processor (e.g., a central processing unit (CPU) or other main processor); memory (e.g., one or more volatile or non-volatile random-access memory (RAM) memory device, such as dynamic RAM (DRAM), mobile or low-power double-data-rate synchronous DRAM (DDR SDRAM), etc.); and a storage device (e.g., non-volatile memory (NVM) device, such as flash memory, read-only memory (ROM), an SSD, an MMC, or other memory card structure or assembly, etc.). In certain examples, electronic devices can include a user interface (e.g., a display, touch-screen, keyboard, one or more buttons, etc.), a graphics processing unit (GPU), a power management circuit, a baseband processor or one or more transceiver circuits, etc.

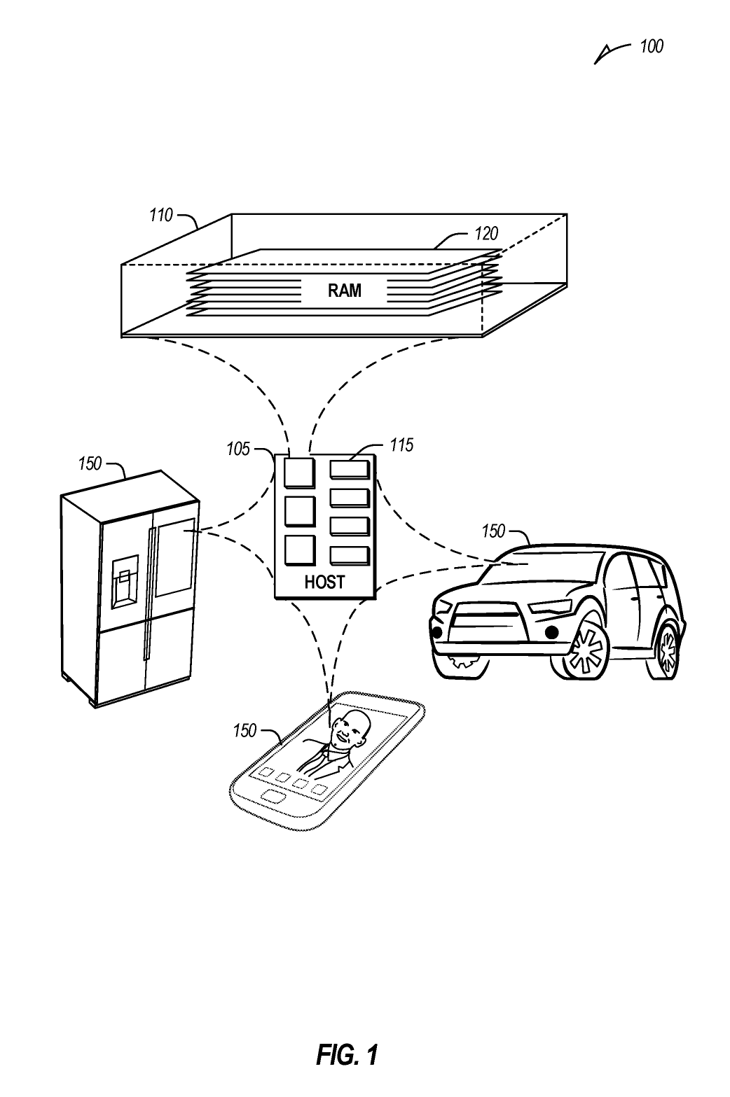

FIG. 1 illustrates an example of an environment 100 including a host device 105 and a memory device 110 configured to communicate over a communication interface. The host device 105 or the memory device 110 may be included in a variety of products 150, such as Internet of Things (IoT) devices (e.g., a refrigerator or other appliance, sensor, motor or actuator, mobile communication device, automobile, drone, etc.) to support processing, communications, or control of the product 150.

The host device 105 includes a memory controller 115 and the memory device 110 includes a memory array 120 including, for example, a number of individual memory chips, ranks, or banks. In an example, the memory device 110 can be a discrete memory or storage device component of the host device 105. In other examples, the memory device 110 can be a portion of an integrated circuit (e.g., system on a chip (SOC), etc.), stacked or otherwise included with one or more other components of the host device 105.

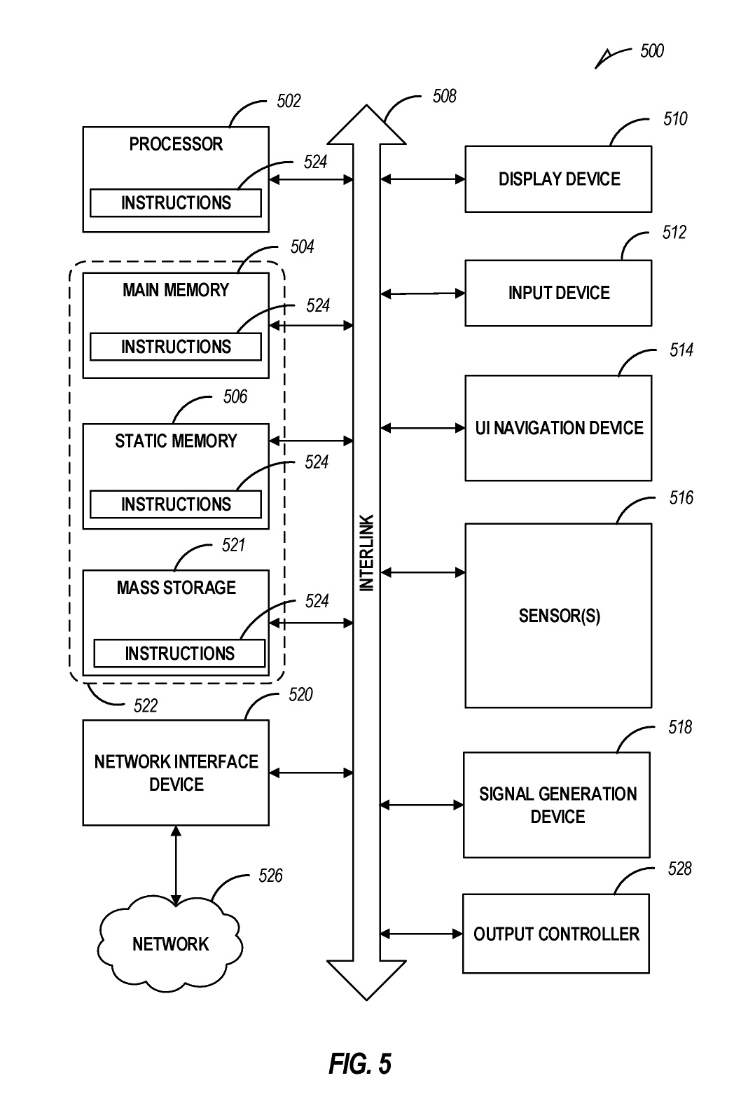

One or more communication interfaces can be used to transfer data between the memory device 110 and one or more other components of the host device 105. The host device 105 can include a host system, an electronic device, a processor, a memory card reader, or one or more other electronic devices external to the memory device 110. In some examples, the host 105 may be a machine having some portion, or all, of the components discussed in reference to the machine 500 of FIG. 5.

The memory controller 115 can receive instructions from the host 105, and can communicate with the memory array 120, such as to transfer data to (e.g., write or erase) or from (e.g., read) one or more of the chips, ranks, or banks of the memory array 120. The memory controller 115 can include, among other things, circuitry or firmware, including one or more components or integrated circuits. For example, the memory controller 115 can include one or more memory control units, circuits, or components configured to control access across the memory array 120 and to provide a translation layer between the host 105 and the memory device 110. The memory controller 115 can include one or more input/output (I/O) circuits, lines, or interfaces to transfer data to or from the memory array 120.

The memory controller 115 can include, among other things, circuitry or firmware, such as a number of components or integrated circuits associated with various memory management functions, as de-fragmentation. The memory controller 115 can parse or format host commands (e.g., commands received from a host) into device commands (e.g., commands associated with operation of a memory array, etc.), or generate device commands (e.g., to accomplish various memory management functions) for the array 120 or one or more other components of the memory device 110.

The memory controller 115 can include, among other things, circuitry or components configured to control memory operations associated with writing data to, reading data from, or erasing one or more memory cells of the memory device 110. The memory operations can be based on, for example, host commands received from the host 105, or internally generated by the memory controller 115 (e.g., in association with defragmentation, error correction, refresh, etc.).

The memory controller 115 can include an error correction code (ECC) component, which can include, among other things, an ECC engine or other circuitry configured to detect or correct errors associated with writing data to or reading data from one or more memory cells of the memory device 110 coupled to the memory controller 115. The memory controller 115 can be configured to actively detect and recover from error occurrences (e.g., bit errors, operation errors, etc.) associated with various operations or storage of data, while maintaining integrity of the data transferred between the host 105 and the memory device 110, or maintaining integrity of stored data (e.g., using redundant RAID storage, etc.), and can remove (e.g., retire) failing memory resources to prevent future errors.

An MMU, mobile management unit, power monitor, the memory controller 115, or other component of the host 105 may be employed to enact various energy saving procedures. While low power consumption has become increasingly important with the proliferation of battery powered devices, large server installations may also benefit from aggressive energy reduction. For simplicity, the following energy reduction techniques are implemented via the controller 210, however any of the other components mentioned above may perform one or more of these techniques.

The memory controller 115 is arranged to obtain (e.g., retrieve or receive) a trigger. In an example, the trigger is initiation of a RAM maintenance operation. In an example, the RAM maintenance operation is a de-fragmentation operation. In an example, the RAM maintenance operation is a garbage collection operation. In an example, the trigger is the expiration of a time period.

In an example, the trigger is host inactivity. In an example, the host inactivity is triggered when a display of the host is off. In an example, the display is integrated into a housing of the host 105. In an example, the host 105 is a mobile device (e.g., battery operated) such as a phone, laptop computer, tablet, sensor, etc. In an example, the host is operable away from mains power. In an example, the host is operable with a battery. In an example, the trigger is a low-power state of a host. In an example, the low-power state is based on a power level of the battery.

The controller 115 is arranged to compress data contained in the memory device 110 to create compressed data in response to the trigger. In an example, the memory device 110 is organized into several discrete hardware components with a corresponding power control. Thus, these components can be individually powered down (e.g., effectively consume no power) via the power control.

The controller 115 is arranged to replace the data with the compressed data in the memory device 110. This frees a discrete hardware component of the memory device 110. In an example, the discrete hardware component is a bank. In an example, the discrete hardware component is a chip. In an example, the discrete hardware component is a string. In an example, the discrete hardware component is a bus. The compressed data may be used as regular RAM data by uncompressing it as it is read and mapping logical memory addresses of uncompressed data to the compressed portions. Various implementations exist, such as the zRAM or zRAM+ implementations available for the Linux® operating system.

The controller 115 is arranged to power down the discrete hardware component is powered down via the corresponding power control. Shutting down the component provides energy savings to the host 105. As noted above, this energy savings may provide greater duration from battery powered devices, or save on data center costs for mains powered devices.

In an example, alternative or complimentary operations may be performed to free hardware components of the memory device 110. For example, the de-fragmentation of memory may consolidate memory freeing a block, for example. In an example, data may be moved to another media, such as non-volatile media (e.g., disk, FLASH, etc.). These techniques may be used in conjunction with compression to free hardware components, allowing these components to be powered down.

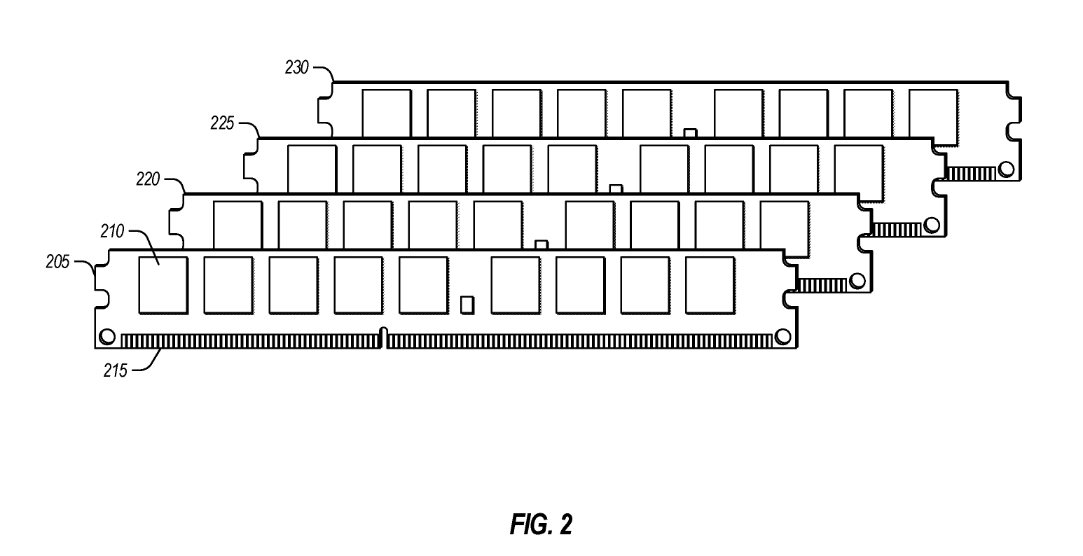

FIG. 2 illustrates an example of components in RAM subject to power control. FIG. 2 uses the dual in-line memory module (DIMM) configuration to more clearly identify the components. However, in other configurations, these packages may appear differently. As illustrated, there are four banks, bank 205, bank 220, bank 225, and bank 230. In an example, each bank (e.g., bank 205) or a group of banks (e.g., banks 225 and 230) may be selectively powered off via power control.

A bank may include one or more chips, such as chip 210. In an example, the chips may be organized in ranks (e.g., a set of chips accessed by the same chip select). Individual chips (e.g., chip 210), or a set of chips may be selectively powered off via power control.

The memory also includes an interlink 215. The interlink 215 is illustrated as connecting the bank 205 to a host (e.g., via a memory controller), but can also refer to inter-bank connections. The interlink 215 may be selectively power off via power control.

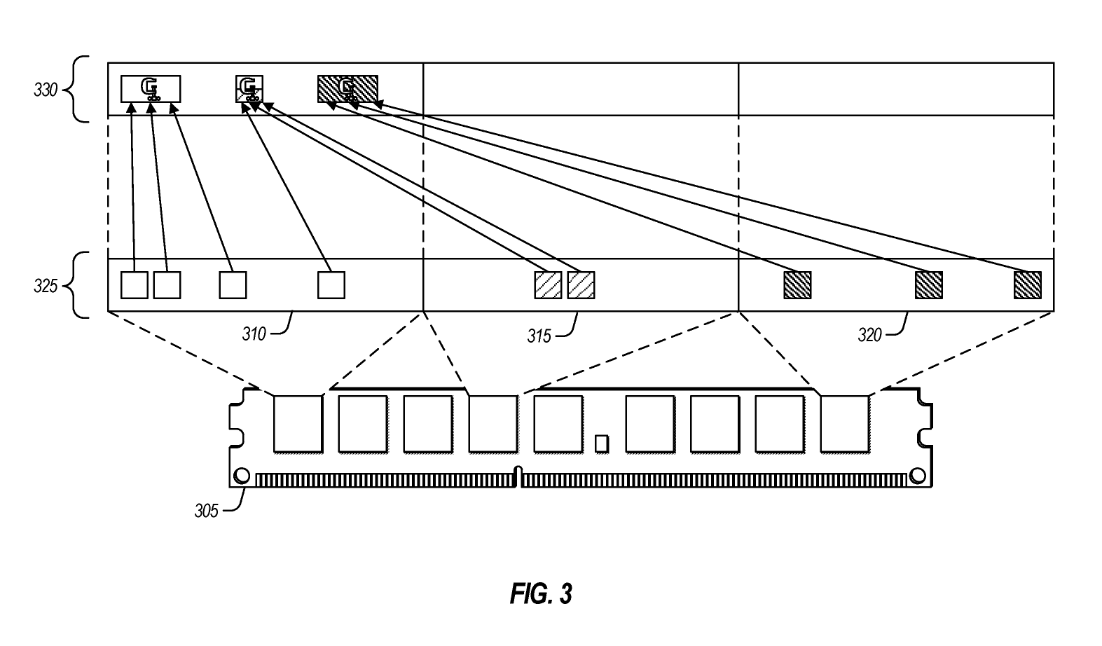

FIG. 3 illustrates an example of compressing RAM. Bank 305 includes chips (e.g., chip 210, chip 315, and chip 320) with uncompressed data 325. The uncompressed data 325 is compressed. The compressed data 330 is now capable of residing on one chip, chip 310, freeing chips 315 and 320. As described above, chips 315 and 320 may then be powered down.

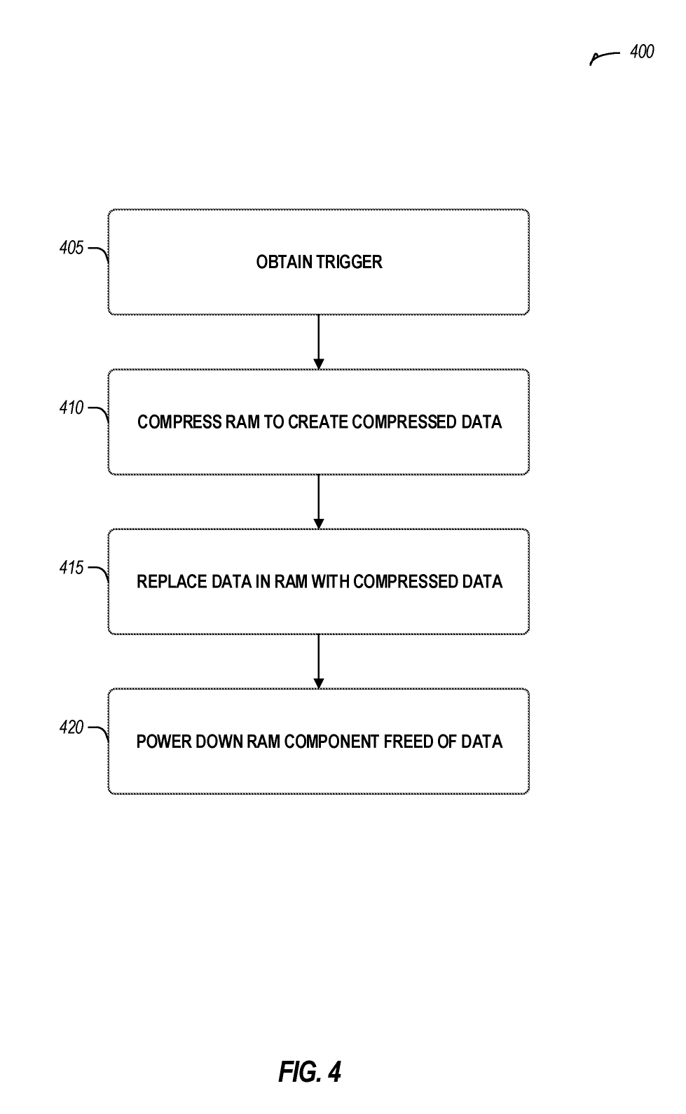

FIG. 4 illustrates an example flowchart of a method 400 for RAM power savings. Operations of the method 400 are performed by hardware, such as that described above with respect to FIGS. 1-3, or below with respect to FIG. 5 (e.g., processing circuitry). In an example, the RAM is dynamic RAM (DRAM). In an example, the RAM is static RAM (SRAM).

At operation 405, a trigger is obtained. In an example, the trigger is initiation of a RAM maintenance operation. In an example, the RAM maintenance operation is a de-fragmentation operation. In an example, the trigger is the expiration of a time period.

In an example, the trigger is host inactivity. Here, the host is a device communicatively coupled to the RAM when in operation. In an example, the host inactivity is triggered when a display of the host is off. In an example, the display is integrated into a housing of the host. In an example, the host is a mobile device.

In an example, the trigger is a low-power state of a host. In an example, the host is operable away from mains power. In an example, the host is operable with a battery. In an example, the low-power state is based on a power level of the battery.

At operation 410, data contained in the RAM is compressed to create compressed data in response to the trigger. In an example, the RAM is organized into several discrete hardware components with a corresponding power control.

At operation 415, the data contained in the RAM is replaced with the compressed data in the RAM freeing a discrete hardware component of the RAM of data. In an example, the discrete hardware component is a bank. In an example, the discrete hardware component is a chip. In an example, the discrete hardware component is a string. In an example, the discrete hardware component is a bus.

At operation 420, the discrete hardware component is powered down via the corresponding power control.

In an example, the operations of obtaining the trigger (operation 405), compressing the data (operation 410), replacing the data (operation 415, and powering down the discrete hardware component (operation 420) are performed by a mobile management unit (MMU) of the host.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine (e.g., computer system) 500 (e.g., the host device 105, the memory device 110, etc.) may include a hardware processor 502 (e.g., a central processing unit (CPU), a graphics processing unit (GPU), a hardware processor core, or any combination thereof, such as the memory controller 115, etc.), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute the machine readable medium 522.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine-readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 (e.g., software, programs, an operating system (OS), etc.) or other data are stored on the storage device 521, can be accessed by the memory 504 for use by the processor 502. The memory 504 (e.g., DRAM) is typically fast, but volatile, and thus a different type of storage than the storage device 521 (e.g., an SSD), which is suitable for long-term storage, including while in an “off” condition. The instructions 524 or data in use by a user or the machine 500 are typically loaded in the memory 504 for use by the processor 502. When the memory 504 is full, virtual space from the storage device 521 can be allocated to supplement the memory 504; however, because the storage 521 device is typically slower than the memory 504, and write speeds are typically at least twice as slow as read speeds, use of virtual memory can greatly reduce user experience due to storage device latency (in contrast to the memory 504, e.g., DRAM). Further, use of the storage device 521 for virtual memory can greatly reduce the usable lifespan of the storage device 521.

In contrast to virtual memory, virtual memory compression (e.g., the Linux® kernel feature “ZRAM”) uses part of the memory as compressed block storage to avoid paging to the storage device 521. Paging takes place in the compressed block until it is necessary to write such data to the storage device 521. Virtual memory compression increases the usable size of memory 504, while reducing wear on the storage device 521.

Storage devices optimized for mobile electronic devices, or mobile storage, traditionally include MMC solid-state storage devices (e.g., micro Secure Digital (microSDTM) cards, etc.). MMC devices include a number of parallel interfaces (e.g., an 8-bit parallel interface) with a host device, and are often removable and separate components from the host device. In contrast, eMMC™ devices are attached to a circuit board and considered a component of the host device, with read speeds that rival serial ATA™ (Serial AT (Advanced Technology) Attachment, or SATA) based SSD devices. However, demand for mobile device performance continues to increase, such as to fully enable virtual or augmented-reality devices, utilize increasing networks speeds, etc. In response to this demand, storage devices have shifted from parallel to serial communication interfaces. Universal Flash Storage (UFS) devices, including controllers and firmware, communicate with a host device using a low-voltage differential signaling (LVDS) serial interface with dedicated read/write paths, further advancing greater read/write speeds.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Examples

Example 1 is a device for random access memory power (RAM) savings, the device comprising processing circuitry to: obtain a trigger; compress, in response to the trigger, data contained in a RAM to create compressed data, the RAM organized into several discrete hardware components with a corresponding power control; replace the data contained in the RAM with the compressed data in the RAM freeing a discrete hardware component of the RAM; and power down the discrete hardware component via the corresponding power control.

In Example 2, the subject matter of Example 1 includes, wherein the discrete hardware component is a bank.

In Example 3, the subject matter of Examples 1-2 includes, wherein the discrete hardware component is a chip.

In Example 4, the subject matter of Examples 1-3 includes, wherein the discrete hardware component is a string.

In Example 5, the subject matter of Examples 1-4 includes, wherein the discrete hardware component is a bus.

In Example 6, the subject matter of Examples 1-5 includes, wherein the trigger is initiation of a RAM maintenance operation.

In Example 7, the subject matter of Example 6 includes, wherein the RAM maintenance operation is a de-fragmentation operation.

In Example 8, the subject matter of Examples 1-7 includes, wherein the trigger is host inactivity, wherein the host is a device communicatively coupled to the RAM when in operation.

In Example 9, the subject matter of Example 8 includes, wherein the host inactivity is triggered when a display of the host is off.

In Example 10, the subject matter of Example 9 includes, wherein the display is integrated into a housing of the host.

In Example 11, the subject matter of Example 10 includes, wherein the host is a mobile device.

In Example 12, the subject matter of Examples 1-11 includes, wherein the trigger is the expiration of a time period.

In Example 13, the subject matter of Examples 1-12 includes, wherein the trigger is a low-power state of a host, wherein the host is a device communicatively coupled to the RAM when in operation, and wherein the host is operable away from mains power.

In Example 14, the subject matter of Example 13 includes, wherein the host is operable with a battery, and wherein the low-power state is based on a power level of the battery.

In Example 15, the subject matter of Examples 1-14 includes, wherein the device is a mobile management unit (MMU) of a host, wherein the host is a device communicatively coupled to the RAM when in operation.

In Example 16, the subject matter of Examples 1-15 includes, wherein the RAM is dynamic RAM (DRAM).

In Example 17, the subject matter of Examples 1-16 includes, wherein the RAM is static RAM (SRAM).

Example 18 is a method for random access memory power (RAM) savings, the method comprising: obtaining a trigger; compressing, in response to the trigger, data contained in a RAM to create compressed data, the RAM organized into several discrete hardware components with a corresponding power control; replacing the data contained in the RAM with the compressed data in the RAM freeing a discrete hardware component of the RAM; and powering down the discrete hardware component via the corresponding power control.

In Example 19, the subject matter of Example 18 includes, wherein the discrete hardware component is a bank.

In Example 20, the subject matter of Examples 18-19 includes, wherein the discrete hardware component is a chip.

In Example 21, the subject matter of Examples 18-20 includes, wherein the discrete hardware component is a string.

In Example 22, the subject matter of Examples 18-21 includes, wherein the discrete hardware component is a bus.

In Example 23, the subject matter of Examples 18-22 includes, wherein the trigger is initiation of a RAM maintenance operation.

In Example 24, the subject matter of Example 23 includes, wherein the RAM maintenance operation is a de-fragmentation operation.

In Example 25, the subject matter of Examples 18-24 includes, wherein the trigger is host inactivity, wherein the host is a device communicatively coupled to the RAM when in operation.

In Example 26, the subject matter of Example 25 includes, wherein the host inactivity is triggered when a display of the host is off.

In Example 27, the subject matter of Example 26 includes, wherein the display is integrated into a housing of the host.

In Example 28, the subject matter of Example 27 includes, wherein the host is a mobile device.

In Example 29, the subject matter of Examples 18-28 includes, wherein the trigger is the expiration of a time period.

In Example 30, the subject matter of Examples 18-29 includes, wherein the trigger is a low-power state of a host, wherein the host is a device communicatively coupled to the RAM when in operation, and wherein the host is operable away from mains power.

In Example 31, the subject matter of Example 30 includes, wherein the host is operable with a battery, and wherein the low-power state is based on a power level of the battery.

In Example 32, the subject matter of Examples 18-31 includes, wherein the operations of obtaining the trigger, compressing the data, replacing the data and powering down the discrete hardware component are performed by a mobile management unit (MMU) of a host, wherein the host is a device communicatively coupled to the RAM when in operation.

In Example 33, the subject matter of Examples 18-32 includes, wherein the RAM is dynamic RAM (DRAM).

In Example 34, the subject matter of Examples 18-33 includes, wherein the RAM is static RAM (SRAM).

Example 35 is at least one machine readable medium including instructions that, when executed by processing circuitry, cause the processing circuitry to perform any method of Examples 18-34.

Example 36 is a system comprising means to perform any method of Examples 18-34.

Example 37 is at least one machine readable medium including instructions that, when executed by processing circuitry, cause the processing circuitry to perform operations comprising: obtaining a trigger; compressing, in response to the trigger, data contained in a RAM to create compressed data, the RAM organized into several discrete hardware components with a corresponding power control; replacing the data contained in the RAM with the compressed data in the RAM freeing a discrete hardware component of the RAM; and powering down the discrete hardware component via the corresponding power control.

In Example 38, the subject matter of Example 37 includes, wherein the discrete hardware component is a bank.

In Example 39, the subject matter of Examples 37-38 includes, wherein the discrete hardware component is a chip.

In Example 40, the subject matter of Examples 37-39 includes, wherein the discrete hardware component is a string.

In Example 41, the subject matter of Examples 37-40 includes, wherein the discrete hardware component is a bus.

In Example 42, the subject matter of Examples 37-41 includes, wherein the trigger is initiation of a RAM maintenance operation.

In Example 43, the subject matter of Example 42 includes, wherein the RAM maintenance operation is a de-fragmentation operation.

In Example 44, the subject matter of Examples 37-43 includes, wherein the trigger is host inactivity, wherein the host is a device communicatively coupled to the RAM when in operation.

In Example 45, the subject matter of Example 44 includes, wherein the host inactivity is triggered when a display of the host is off.

In Example 46, the subject matter of Example 45 includes, wherein the display is integrated into a housing of the host.

In Example 47, the subject matter of Example 46 includes, wherein the host is a mobile device.

In Example 48, the subject matter of Examples 37-47 includes, wherein the trigger is the expiration of a time period.

In Example 49, the subject matter of Examples 37-48 includes, wherein the trigger is a low-power state of a host, wherein the host is a device communicatively coupled to the RAM when in operation, and wherein the host is operable away from mains power.

In Example 50, the subject matter of Example 49 includes, wherein the host is operable with a battery, and wherein the low-power state is based on a power level of the battery.

In Example 51, the subject matter of Examples 37-50 includes, wherein the operations of obtaining the trigger, compressing the data, replacing the data and powering down the discrete hardware component are performed by a mobile management unit (MMU) of a host, wherein the host is a device communicatively coupled to the RAM when in operation.

In Example 52, the subject matter of Examples 37-51 includes, wherein the RAM is dynamic RAM (DRAM).

In Example 53, the subject matter of Examples 37-52 includes, wherein the RAM is static RAM (SRAM).

Example 54 is a system for random access memory power (RAM) savings, the system comprising: means for obtaining a trigger; means for compressing, in response to the trigger, data contained in a RAM to create compressed data, the RAM organized into several discrete hardware components with a corresponding power control; means for replacing the data contained in the RAM with the compressed data in the RAM freeing a discrete hardware component of the RAM; and means for powering down the discrete hardware component via the corresponding power control.

In Example 55, the subject matter of Example 54 includes, wherein the discrete hardware component is a bank.

In Example 56, the subject matter of Examples 54-55 includes, wherein the discrete hardware component is a chip.

In Example 57, the subject matter of Examples 54-56 includes, wherein the discrete hardware component is a string.

In Example 58, the subject matter of Examples 54-57 includes, wherein the discrete hardware component is a bus.

In Example 59, the subject matter of Examples 54-58 includes, wherein the trigger is initiation of a RAM maintenance operation.

In Example 60, the subject matter of Example 59 includes, wherein the RAM maintenance operation is a de-fragmentation operation.

In Example 61, the subject matter of Examples 54-60 includes, wherein the trigger is host inactivity, wherein the host is a device communicatively coupled to the RAM when in operation.

In Example 62, the subject matter of Example 61 includes, wherein the host inactivity is triggered when a display of the host is off.

In Example 63, the subject matter of Example 62 includes, wherein the display is integrated into a housing of the host.

In Example 64, the subject matter of Example 63 includes, wherein the host is a mobile device.

In Example 65, the subject matter of Examples 54-64 includes, wherein the trigger is the expiration of a time period.

In Example 66, the subject matter of Examples 54-65 includes, wherein the trigger is a low-power state of a host, wherein the host is a device communicatively coupled to the RAM when in operation, and wherein the host is operable away from mains power.

In Example 67, the subject matter of Example 66 includes, wherein the host is operable with a battery, and wherein the low-power state is based on a power level of the battery.

In Example 68, the subject matter of Examples 54-67 includes, wherein the means for obtaining the trigger, compressing the data, replacing the data and powering down the discrete hardware component are contained in a mobile management unit (MMU) of a host, wherein the host is a device communicatively coupled to the RAM when in operation.

In Example 69, the subject matter of Examples 54-68 includes, wherein the RAM is dynamic RAM (DRAM).

In Example 70, the subject matter of Examples 54-69 includes, wherein the RAM is static RAM (SRAM).

Example 71 is at least one machine-readable medium including instructions that, when executed by processing circuitry, cause the processing circuitry to perform operations to implement of any of Examples 1-70.

Example 72 is an apparatus comprising means to implement of any of Examples 1-70.

Example 73 is a system to implement of any of Examples 1-70.

Example 74 is a method to implement of any of Examples 1-70.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” may include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” (in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

As used herein, directional adjectives, such as horizontal, vertical, normal, parallel, perpendicular, etc., can refer to relative orientations, and are not intended to require strict adherence to specific geometric properties, unless otherwise noted. For example, as used herein, a vertical structure need not be strictly perpendicular to a surface of a substrate, but may instead be generally perpendicular to the surface of the substrate, and may form an acute angle with the surface of the substrate (e.g., between 60 and 120 degrees, etc.).

In some embodiments described herein, different doping configurations may be applied to a source-side select gate (SGS), a control gate (CG), and a drain-side select gate (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (e.g., the memory cell may be programmed to an erased state).

According to one or more embodiments of the present disclosure, a memory controller (e.g., a processor, controller, firmware, etc.) located internal or external to a memory device, is capable of determining (e.g., selecting, setting, adjusting, computing, changing, clearing, communicating, adapting, deriving, defining, utilizing, modifying, applying, etc.) a quantity of wear cycles, or a wear state (e.g., recording wear cycles, counting operations of the memory device as they occur, tracking the operations of the memory device it initiates, evaluating the memory device characteristics corresponding to a wear state, etc.)

According to one or more embodiments of the present disclosure, a memory access device may be configured to provide wear cycle information to the memory device with each memory operation. The memory device control circuitry (e.g., control logic) may be programmed to compensate for memory device performance changes corresponding to the wear cycle information. The memory device may receive the wear cycle information and determine one or more operating parameters (e.g., a value, characteristic) in response to the wear cycle information.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact discs and digital video disks), magnetic cassettes, memory cards or sticks, random access memories (RAMS), read only memories (ROMs), solid state drives (SSDs), Universal Flash Storage (UFS) device, embedded MMC (eMMC) device, and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A device for random access memory power (RAM) savings, the device comprising processing circuitry to:
obtain a trigger;
compress, in response to the trigger, data contained in a RAM to create compressed data, the RAM organized into several discrete hardware components with a corresponding power control;
replace the data contained in the RAM with the compressed data in the RAM freeing a discrete hardware component of the RAM; and
power down the discrete hardware component via the corresponding power control.

2. The device of claim 1, wherein the discrete hardware component is a bank.

3. The device of claim 1, wherein the discrete hardware component is a chip.

4. The device of claim 1, wherein the discrete hardware component is a bus.

5. The device of claim 1, wherein the trigger is initiation of a RAM maintenance operation.

6. The device of claim 5, wherein the RAM maintenance operation is a de-fragmentation operation.

7. The device of claim 1, wherein the trigger is host inactivity, wherein the host is a device communicatively coupled to the RAM when in operation.

8. The device of claim 7, wherein the host inactivity is triggered when a display of the host is off.

9. The device of claim 1, wherein the trigger is a low-power state of a host, wherein the host is a device communicatively coupled to the RAM when in operation, and wherein the host is operable away from mains power.

10. The device of claim 1, wherein the device is a mobile management unit (MMU) of a host, wherein the host is a device communicatively coupled to the RAM when in operation.

11. A method for random access memory power (RAM) savings, the method comprising:
obtaining a trigger;
compressing, in response to the trigger, data contained in a RAM to create compressed data, the RAM organized into several discrete hardware components with a corresponding power control;
replacing the data contained in the RAM with the compressed data in the RAM freeing a discrete hardware component of the RAM; and
powering down the discrete hardware component via the corresponding power control.

12. The method of claim 11, wherein the discrete hardware component is a bank.

13. The method of claim 11, wherein the discrete hardware component is a chip.

14. The method of claim 11, wherein the discrete hardware component is a bus.

15. The method of claim 11, wherein the trigger is initiation of a RAM maintenance operation.

16. The method of claim 15, wherein the RAM maintenance operation is a de-fragmentation operation.

17. The method of claim 11, wherein the trigger is host inactivity, wherein the host is a device communicatively coupled to the RAM when in operation.

18. The method of claim 17, wherein the host inactivity is triggered when a display of the host is off.

19. The method of claim 11, wherein the trigger is a low-power state of a host, wherein the host is a device communicatively coupled to the RAM when in operation, and wherein the host is operable away from mains power.

20. The method of claim 11, wherein the operations of obtaining the trigger, compressing the data, replacing the data and powering down the discrete hardware component are performed by a mobile management unit (MMU) of a host, wherein the host is a device communicatively coupled to the RAM when in operation.

21. At least one machine readable medium including instructions that, when executed by processing circuitry, cause the processing circuitry to perform operations comprising:
obtaining a trigger;
compressing, in response to the trigger, data contained in a RAM to create compressed data, the RAM organized into several discrete hardware components with a corresponding power control;
replacing the data contained in the RAM with the compressed data in the RAM freeing a discrete hardware component of the RAM; and
powering down the discrete hardware component via the corresponding power control.

22. The machine readable medium of claim 21, wherein the discrete hardware component is a bank.

23. The machine readable medium of claim 21, wherein the discrete hardware component is a chip.

24. The machine readable medium of claim 21, wherein the discrete hardware component is a bus.

25. The machine readable medium of claim 21, wherein the trigger is initiation of a RAM maintenance operation.

26. The machine readable medium of claim 25, wherein the RAM maintenance operation is a de-fragmentation operation.

27. The machine readable medium of claim 21, wherein the trigger is host inactivity, wherein the host is a device communicatively coupled to the RAM when in operation.

28. The machine readable medium of claim 27, wherein the host inactivity is triggered when a display of the host is off.

29. The machine readable medium of claim 21, wherein the trigger is a low-power state of a host, wherein the host is a device communicatively coupled to the RAM when in operation, and wherein the host is operable away from mains power.

30. The machine readable medium of claim 21, wherein the operations of obtaining the trigger, compressing the data, replacing the data and powering down the discrete hardware component are performed by a mobile management unit (MMU) of a host, wherein the host is a device communicatively coupled to the RAM when in operation.
